(19) United States
(12) Patent Application Publication
(10) Pub. No.: US 2008/0243475 A1
(43) Pub. Date: Oct. 2, 2008

(54) WEB CONTENT TRANSLATION SYSTEM, METHOD, AND SOFTWARE

(76) Inventors: Steven Scott Everhart, Waterville, OH (US); Nathan Ewell Tolson Waddell, Germantown, TN (US); Steven A. Everhart, Waterville, OH (US)

Correspondence Address: FRASER CLEMENS MARTIN & MILLER LLC, 28366 KENSINGTON LANE, PERRYSBURG, OH, 43551, US

(21) Appl. No.: 12/049,505

(22) Filed: Mar. 17, 2008

Related U.S. Application Data
(60) Provisional application No. 60/895,171, filed on Mar. 16, 2007.

(51) Int. Cl. G06F 17/28

(52) U.S. Cl. 704/3

(57) ABSTRACT

A translation system and method for translating web content are disclosed. The system and method utilize an interconnection of a desired content source and a web-based translator to provide an on-the-fly translation of the web content of the desired content source. Specifically, the translation system comprises a web-based translator adapted to receive a text input and transmit a translated output, and a code bridge adapted to provide a data interconnection between the translator and a content source, wherein the code bridge extracts the text input from the content source, connects to the translator, and transmits the translated output to the content source.

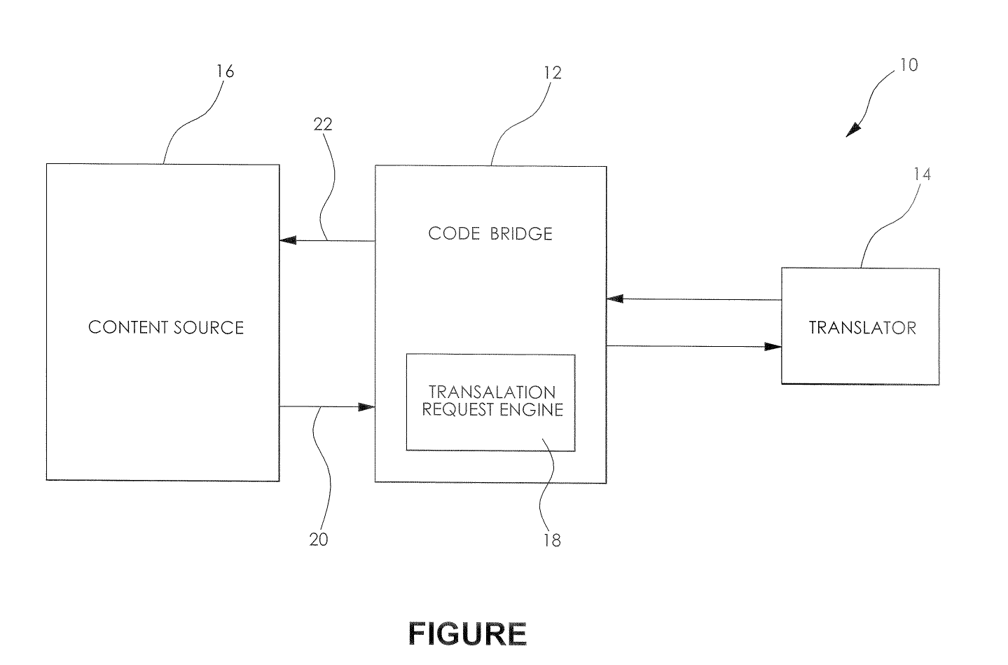

### CROSS-REFERENCE TO RELATED APPLICATION

This application claims the benefit of U.S. Provisional Patent Application Ser. No. 60/895,171 filed on Mar. 16, 2007.

### FIELD OF THE INVENTION

The invention relates to language translation. More particularly, the invention is directed to a web content translation system and method for translating web content of a desired content source.

### BACKGROUND OF THE INVENTION

The Google search engine provides language tools, as shown on the following pages, at http://www.google.com/language_tools?hl+en. One tool is used to Search Specific Languages or Countries including: a) search for web pages written in a selected language; b) search for pages located in a selected country; and c) search for selected words. Another tool translates text provided by the user into a selected language or translates a selected web page into a selected language.

A web content syndication platform is described in U.S. Patent Application Publication No. 2006/0288239. The platform can acquire and organize web content, and make such content available for consumption by many different types of applications. An application program interface exposes an object model which allows applications and users to easily accomplish many different tasks such as creating, reading, updating, deleting feeds and the like.

In paragraph [0037], it is stated that from an object model perspective, there are basically two different types of methods and properties on an item. A first type of method/property pertains to data which is read only, and a second type of method/property pertains to data which can be both read and written.

In paragraph [0038], it is stated that as an example of the first type of method property, consider the following. Each feed can have data associated with it that is represented in an XML structure. This data includes such things as the title, author, language and the like. Data such as this is treated by the object model as read only. For example, the data that is received by a feed and associated with individual items is typically treated as read only. This prevents applications from manipulating this data. Using an XML structure to represent the feed data also carried with it advantages as follows. Assume that the synchronization engine does not understand a new XML element that has been added. Nonetheless, the synchronization engine can still store the element and its associated data as part of the feed item data. For those applications that do understand the element, this element and its associated data are still available for the application to discover and consume.

It would be desirable to have a translation system and method for translating web content, wherein the system and method utilize an interconnection of a desired content source and a web-based translator to provide an on-the-fly translation of the web content of the desired content source.

### SUMMARY OF THE INVENTION

Concordant and consistent with the present invention, a translation system and method for translating web content, wherein the system and method utilize an interconnection of a desired content source and a web-based translator to provide an on-the-fly translation of the web content of the desired content source, has surprisingly been discovered.

In one embodiment, a translation system comprises a web-based translator adapted to receive a text input and transmit a translated output, and a code bridge adapted to provide a data interconnection between the translator and the content source, wherein the code bridge extracts the text input from the content source, connects to the translator, and transmits the translated output to the content source.

In another embodiment, a computer-readable medium has computer-executable instructions for performing a method for translating web content. The method comprises the steps of: extracting a text input from a content source, the text input including a desired printed text and a plurality parameters; translating the text input through a web-based translator; and transmitting a translated output to the content source.

The invention also provides methods for translating web content.

One method comprises the steps of: providing a content source compatible with a plug-in application; providing a web-based translator adapted to receive a text input and transmit a translated output; providing a code bridge adapted to establish a data interconnection between the translator and the content source; extracting the text input from the content source, the text input including a desired printed text and a plurality of parameters; translating the text input through the translator; and transmitting the translated output to the content source.

### BRIEF DESCRIPTION OF THE DRAWINGS

The above, as well as other advantages of the present invention will become readily apparent to those skilled in the art from the following detailed description of the preferred embodiment when considered in the light of the accompanying drawing which is a schematic layout of a translator system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Referring to the FIGURE, there is illustrated a translation system 10 which includes a code bridge 12 and a translator 14. As shown, the translation system 10 is interconnected to a content source 16. The translation system 10 is adapted to receive data from the content source 16 and send data to the content source 16. It is understood that the content source 16 may be any conventional programmable application that is compatible with a plug-in application such as: Windows Vista RSS feeds; AIM (AOL Instant Messenger); MSN Messenger, QQ (Chinese heavily use this Chinese instant messenger); Yahoo Instant Messenger; Trillian Instant Messenger; SMS text message; Jabber Instant Messenger; Adobe Reader (translate PDFs); Firefox Web Browser; Internet Explorer Web Browser; Win amp; and Windows Media Player, for example. As a non-limiting example, the content source 16 may be a Content Management System (CMS). It is understood that the content source 16 may be a single application or a mash-up, for example.

The code bridge 12 provides data communication between the content source 16 and the translator 14 utilizing the underlying program code of the content source 16 and the translator 14. The code bridge 12 includes a translation request engine 18. The translation request engine 18 is created in a substantially universal programming language such as Perl, for example. Other appropriate programming languages may be used, as desired. The translation request engine 18 is adapted to receive a text input 20 from the content source 16. Specifically, the translation request engine 18 is adapted to extract a desired printed text from the content source 16. The text input 20 includes the desired printed text and a plurality of parameters such as a source language of the desired printed text and a desired output language, for example. It is understood that the parameters may be defined by a user. It is further understood that the parameters may be determined through additional code embedded in the code bridge 12. The translation request engine 18 is further adapted to transmit the text input 20 to the translator 14. It is understood that the code bridge 12 may further include plug-in code (not shown). The plug-in code provides a means for the code bridge 12 to interconnect with the content source 16. As a non-limiting example, the code bridge 12 may be embedded in an application through the plug-in code, thereby linking the application to the translator 14. It is understood that the code bridge 12 may be hosted on a server (not shown) to provide remote access to the translation system 10.

The translator 14 is a web application for content transformation. The translator 14 is adapted to receive the text input 20, translate the text input 20 in accordance with the parameters, and transmit a translated output 22 to the content source 16 through the code bridge 12. As a non limiting example, the translator 14 may be one of a Google Translation function and Alta Vista's Babel Fish product. Other translation web services for content transformation may be used, as desired. Several companies provide translation web services as freely available services in the same manner as Google. It is understood that the translator 14 may be adapted to translate any world languages and dialects of languages, as desired. It is further understood that the translator may be adapted to provide real time language (vocal) translation.

In operation, the user initiates the translation request engine 18 and provides user defined parameters such as the source language of the desired printed text and the desired output language, collectively referred to as the text input 20. It is understood that the parameters may be determined through additional code embedded in the code bridge 12. The user may initiate the translation request engine 18 through any conventional graphical user interface (GUI) such as a toolbar, an HTML widget, and a graphical icon, for example. Other devices for initiating the translation request engine 18 may be used, as desired. The translation request engine 18 extracts the desired printed text from the content source 16. The translation request engine 18 transmits the text input 20 to the translator 14. The translator 14, in cooperation with the translator request engine 18, translates the text input 20 from the source language to the desired output language. The translator 14 transmits a translated output 22 through the code bridge 12 and to the content source 16. The content source 16 displays the translated output 22 to the user in the desired output language defined by the user. It is understood that the translated output 22 may be modified by a component of the code bridge 12 before the translated output 22 is transmitted to the content source 16. As a non-limiting example, the translated content 22 may be embedded with advertisements. It is further understood that the code bridge 12 and a plurality of associated computer-executable instructions for performing the described method for translating web content may be stored on a computer-readable medium (not shown).

The translation system 10 and method for translating the web content of a desired content source provide the user with a fast, on-the-fly, translation of the content of the desired content source 16. The translation system 10 and method provides a “one click” translation of the content of the desired content source 16. Specifically, once the translation request engine 18 is initiated for the desired content source, the translation system 10 will continue to provide real-time translation without the user having to request a new translation of content.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A translation system comprising:
a web-based translator adapted to receive a text input and transmit a translated output; and
a code bridge adapted to provide a data interconnection between the translator and a content source, wherein the code bridge extracts the text input from the content source, connects to the translator, and transmits the translated output to the content source.

2. The translation system according to claim 1, wherein the code bridge is delivered to the content source utilizing a plug-in application.

3. The translation system according to claim 1, wherein the translator is a web application available to a user.

4. The translation system according to claim 1, wherein the code bridge includes a translation request engine created in a substantially universal programming language.

5. The translation system according to claim 1, wherein the text input includes a parameter that defines the source language.

6. The translation system according to claim 1, wherein the text input includes a parameter that defines the desired output language.

7. The translation system according to claim 1, wherein the content source is a programmable application compatible with a plug-in application.

8. The translation system according to claim 1, wherein the translated output is one of a printable text and an audible signal.

9. A method for translating web content, the method comprising the steps of:
providing a content source compatible with a plug-in application;
providing a web-based translator adapted to receive a text input and transmit a translated output;
providing a code bridge adapted to establish a data interconnection between the translator and the content source;
extracting the text input from the content source, the text input including a desired printed text and a plurality of parameters;
translating the text input through the translator; and
transmitting the translated output to the content source.

10. The method according to claim 9, wherein the code bridge is delivered to the content source utilizing a plug-in application.

11. The method according to claim 9, wherein the translator is a web application available to a user.

12. The method according to claim 9, wherein the code bridge includes a translation request engine created in a substantially universal programming language.

13. The method according to claim 9, wherein the text input includes a parameter that defines the source language.

14. The method according to claim 9, wherein the text input includes a parameter that defines the desired output language.

15. The method according to claim 9, wherein the content source is a programmable application compatible with a plug-in application.

16. The method according to claim 9, wherein the translated output is one of a printable text and an audible signal.

17. A computer-readable medium having computer-executable instructions for performing a method for translating web content, the method comprising the steps of:
extracting a text input from a content source, the text input including a desired printed text and a plurality parameters;
translating the text input through a web-based translator; and
transmitting a translated output to the content source.

18. The computer-readable medium according to claim 17, wherein the computer-executable instructions are executed by a translation request engine created in a substantially universal programming language.

19. The computer-readable medium according to claim 17, wherein the text input includes a parameter that defines the source language.

20. The computer-readable medium according to claim 17, wherein the text input includes a parameter that defines the desired output language.
